(19) United States
(12) Patent Application Publication
(10) Pub. No.: US 2025/0387933 A1
(43) Pub. Date: Dec. 25, 2025

(54) CUTTER HEAD STRUCTURE CAPABLE OF ACHIEVING PARALLEL MOVEMENT

(71) Applicant: DONGGUAN FENG MING TECHNOLOGY AND COMMUNICATIONS CO., LTD., Dongguan (CN)

(72) Inventors: Xuexuan WU, Dongguan (CN); Wei JIANG, Dongguan (CN)

(73) Assignee: DONGGUAN FENG MING TECHNOLOGY AND COMMUNICATIONS CO., LTD., Dongguan (CN)

(21) Appl. No.: 18/937,068

(22) Filed: Nov. 5, 2024

(30) Foreign Application Priority Data
Jun. 21, 2024 (CN) 202410809473.X
Jun. 21, 2024 (CN) 202421444540.4

(51) Int. Cl. B26B 19/04; B26B 19/38

(52) U.S. Cl. CPC B26B 19/04; B26B 19/3866

(57) ABSTRACT

Disclosed in the present disclosure is a cutter head structure capable of achieving parallel movement. The cutter head structure includes a movable cutter assembly, a fixed cutter assembly, rolling members, a pressing member, and a gasket, where the movable cutter assembly is sliding fit with the fixed cutter assembly; the pressing member is provided with a first mounting position and second mounting positions, at least part of the movable cutter assembly is disposed at the first mounting position, and at least part of each of the rolling members is disposed at the second mounting position; and the gasket is disposed on one side of the fixed cutter assembly close to the movable cutter assembly. According to the present disclosure, the contact area between a tail portion of the movable cutter assembly and a tail portion of the fixed cutter assembly can be reduced, thereby reducing friction between the two assemblies.

### TECHNICAL FIELD

The present disclosure relates to the technical field of shavers, in particular to a cutter head structure capable of achieving parallel movement.

### BACKGROUND

A shaver is a tool for shaving hair and includes a fixed cutter assembly and a movable cutter assembly, and front ends of the fixed cutter assembly and the movable cutter assembly are provided with toothed cutting edges. During working of the shaver, the movable cutter assembly moves horizontally and transversely relative to the fixed cutter assembly, so that the toothed cutting edge of the movable cutter assembly has a relatively horizontal and transverse cutting effect relative to the toothed cutting edge of the fixed cutter assembly, thereby shaving the hair.

Under the effects of friction and cutting, the fixed cutter assembly and the movable cutter assembly will generate a lot of heat during working, and if the heat cannot be dissipated timely, the temperature of a cutter head will rise, which affects the stability and service life of the cutter head, and even causes potential safety hazards.

The above defects need to be overcome.

### SUMMARY

In order to solve the problems that the stability and service life of a cutter head are affected due to the rise of the temperature of the cutter head due to the fact that a fixed cutter assembly and a movable cutter assembly in an existing shaver will generate a lot of heat during working, the present disclosure provides a cutter head structure capable of achieving parallel movement.

The technical solution of the present disclosure is as follows:
a cutter head structure capable of achieving parallel movement, comprising a movable cutter assembly, a fixed cutter assembly, and rolling members, where the movable cutter assembly is in horizontal and transverse sliding fit with the fixed cutter assembly; and the cutter head structure further comprises:
a pressing member, where the pressing member is provided with a first mounting position and second mounting positions, at least part of the movable cutter assembly is disposed at the first mounting position, and at least part of each of the rolling members is disposed at the second mounting position; and
a gasket, where the gasket is disposed on one side of the fixed cutter assembly close to the movable cutter assembly, the gasket is provided with limiting portions matched with the second mounting positions, and at least part of each of the rolling members is disposed in the limiting portion.

According to the present disclosure of the above solution, the fixed cutter assembly comprises a fixed cutter head portion, the movable cutter assembly comprises a movable cutter head portion, the fixed cutter head portion is in contact with the movable cutter head portion, the fixed cutter head portion is bent towards one side close to the pressing member to form a fixed cutter tail portion, and the movable cutter head portion is bent towards one side away from the pressing member to form a movable cutter tail portion, so that a gap is formed between the fixed cutter tail portion and the movable cutter tail portion.

According to the present disclosure of the above solution, each of the limiting portions is a sliding groove, and the sliding groove extends in a movement direction of the movable cutter assembly; and each of the second mounting positions comprises an accommodating groove, and the accommodating groove is matched with the sliding groove, so that the rolling member is limited between the accommodating groove and the sliding groove.

According to the present disclosure of the above solution, each of the accommodating grooves is recessed inwards to form a deformation groove which facilitates the accommodating groove wrapping the rolling member.

According to the present disclosure of the above solution, at least part of the gasket extends between the movable cutter assembly and the fixed cutter assembly.

According to the present disclosure of the above solution, the gasket is provided with bosses, sliding grooves serving as the limiting portions are provided on two sides of the bosses, and the sliding grooves extend in a movement direction of the movable cutter assembly.

According to the present disclosure of the above solution, each of the bosses comprises a first side surface and a second side surface, the first side surface and the second side surface extend in the movement direction of the movable cutter assembly, and the first side surface and the second side surface are parallel to each other and are perpendicular to an upper surface of the gasket; and

each of the second mounting positions comprises an accommodating groove, and the accommodating groove is matched with the sliding groove, so that the plurality of rolling members are limited between the accommodating groove and the sliding groove.

According to the present disclosure of the above solution, each of the bosses comprises a first side surface and a second side surface, the first side surface and the second side surface extend in the movement direction of the movable cutter assembly, and the first side surface and the second side surface are inclined inwards; and

each of the second mounting positions comprises an accommodating groove, and the accommodating groove is matched with the sliding groove, so that the plurality of rolling members are limited between the accommodating groove and the sliding groove.

According to the present disclosure of the above solution, each of the limiting portions is a boss, and the boss extends in a movement direction of the movable cutter assembly; and each of the second mounting positions comprises an accommodating groove, and the accommodating groove is matched with the boss, so that the rolling member is limited between the accommodating groove and the boss.

According to the present disclosure of the above solution, the pressing member is provided with inserting columns, the movable cutter assembly is provided with inserting holes, and the inserting columns are inserted into the inserting holes.

According to the present disclosure of the above solution, the cutter head structure further comprises a spring, where limiting grooves are formed in one side of the pressing member away from the movable cutter assembly, a fixed end of the spring is connected to the gasket, and pressure application ends of the spring are disposed in the limiting grooves.

The present disclosure of the above solution has the beneficial effects as follows:
in the cutter head structure capable of achieving parallel movement, at least part of each of the rolling members is disposed at the second mounting position of the pressing member, the gasket is disposed on the side of the fixed cutter assembly close to the movable cutter assembly, the gasket is provided with the limiting portions matched with the second mounting positions, and at least part of each of the rolling members is disposed in the limiting portion, that is, each of the rolling members is disposed between the pressing member and the gasket, so that the contact area between the tail portion of the movable cutter assembly and the tail portion of the fixed cutter assembly can be reduced, thereby reducing friction between the two assemblies, effectively reducing heat, effectively reducing the temperature of a cutter head of a shaver, prolonging the service lives of the fixed cutter assembly and the movable cutter assembly, and ensuring the long-term stability and reliability of the shaver.

In addition, the rolling members are disposed between the pressing member and the gasket, the movable cutter assembly is in horizontal and transverse sliding fit with the fixed cutter assembly to achieve parallel movement and cutting of a blade, and the blade can be closer to the skin to cut hair, thereby improving the cutting safety and comfort. Besides, the gasket plays a role in limiting steel balls, and can also serve as a buffering layer between the fixed cutter assembly and the movable cutter assembly to further reduce friction and vibration.

### BRIEF DESCRIPTION OF THE DRAWINGS

FIG. 1 is a structural schematic diagram of embodiment I;

FIG. 2 is a sectional view of embodiment I;

FIG. 3 is the first exploded view of embodiment I;

FIG. 4 is the second exploded view of embodiment I;

FIG. 5 is a structural schematic diagram of a pressing member in embodiment I;

FIG. 6 is a structural schematic diagram of embodiment II;

FIG. 7 is a sectional view of embodiment II;

FIG. 8 is the first exploded view of embodiment II;

FIG. 9 is the second exploded view of embodiment II;

FIG. 10 is a structural schematic diagram of a pressing member in embodiment III;

FIG. 11 is a structural schematic diagram of embodiment III;

FIG. 12 is a sectional view of embodiment III;

FIG. 13 is the first exploded view of embodiment III;

FIG. 14 is the second exploded view of embodiment III;

FIG. 15 is a structural schematic diagram of a pressing member in embodiment IV;

FIG. 16 is a structural schematic diagram of embodiment IV;

FIG. 17 is a sectional view of embodiment IV;

FIG. 18 is the first exploded view of embodiment IV;

FIG. 19 is the second exploded view of embodiment IV;

FIG. 20 is a structural schematic diagram of the pressing member in embodiment IV;

FIG. 21 is a structural schematic diagram of a rolling member in embodiment IV;

FIG. 22 is a sectional view of embodiment V; and

FIG. 23 is an exploded view of embodiment V.

In the drawings: 1. movable cutter assembly; 11. movable cutter head portion; 12. movable cutter tail portion; 13. inserting hole; 2. fixed cutter assembly; 21. fixed cutter head portion; 22. fixed cutter tail portion; 3. rolling member; 31. groove; 32. rolling column; 4. pressing member; 4a. first pressing member; 4b. second pressing member; 41. inserting column; 42. limiting groove; 43. first mounting position; 431. elastic deformation groove; 44. second mounting position; 441. accommodating groove; 442. deformation groove; 5. spring; 6. gasket; 6a. first gasket; 6b. second gasket; 61. first sliding groove; 62. boss; 63. second sliding groove; 7. fixing member; and 8. connector.

### DETAILED DESCRIPTION OF EMBODIMENTS

In order to make the technical problems to be solved by the present disclosure, the technical solutions and the beneficial effects clearer, the present disclosure is further described in detail in conjunction with accompanying drawings and embodiments below. It should be understood that the specific embodiments described herein are only used to explain the present disclosure, not to define the present disclosure.

### Embodiment I

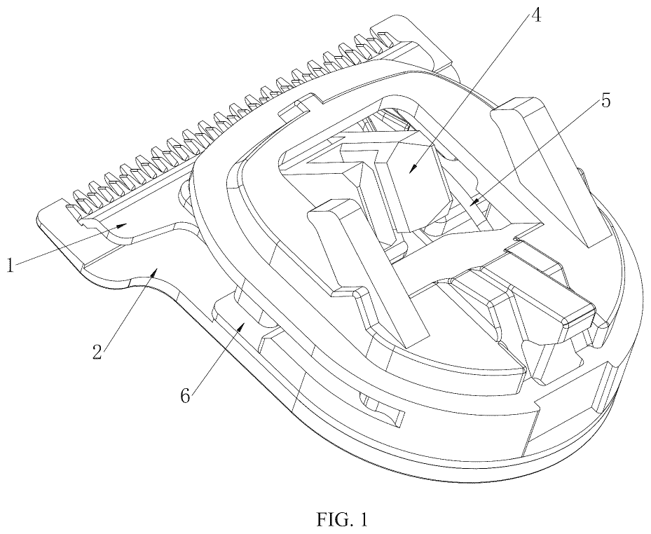

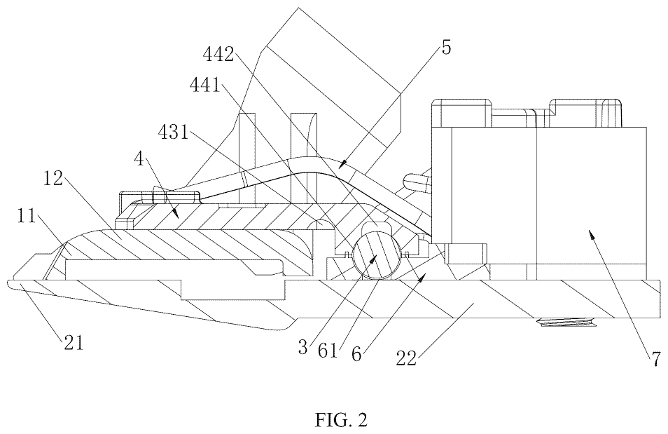

As shown in FIG. 1 and FIG. 2, the present disclosure provides a cutter head structure capable of achieving parallel movement, including a movable cutter assembly 1, a fixed cutter assembly 2, rolling members 3, a pressing member 4, a spring 5, and a gasket 6.

As shown in FIG. 2, in this embodiment, the fixed cutter assembly 2 includes a fixed cutter head portion 21 and a fixed cutter tail portion 22, the movable cutter assembly 1 includes a movable cutter head portion 11 and a movable cutter tail portion 12, the fixed cutter head portion 21 is in contact with the movable cutter head portion 11, and the movable cutter assembly 1 is driven by an electric motor to be in horizontal and transverse sliding fit with the fixed cutter assembly 2, thereby shaving hair. In addition, the fixed cutter head portion 21 is bent towards one side close to the pressing member 4 to form the fixed cutter tail portion 22, and the movable cutter head portion 11 is bent towards one side away from the pressing member 4 to form the movable cutter tail portion 12, so that a gap is formed between the fixed cutter tail portion 22 and the movable cutter tail portion 12, thereby reducing the contact area between the fixed cutter assembly 2 and the movable cutter assembly 1, then reducing friction between the movable cutter assembly 1 and the fixed cutter assembly 2, and reducing heat.

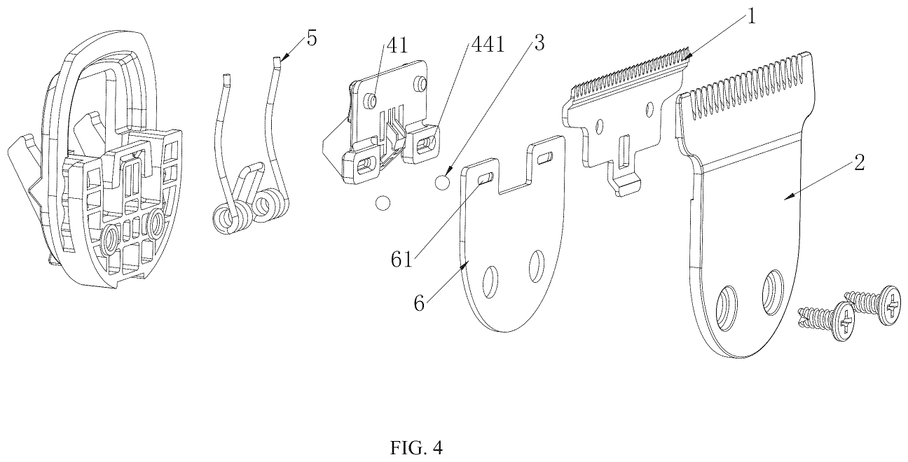

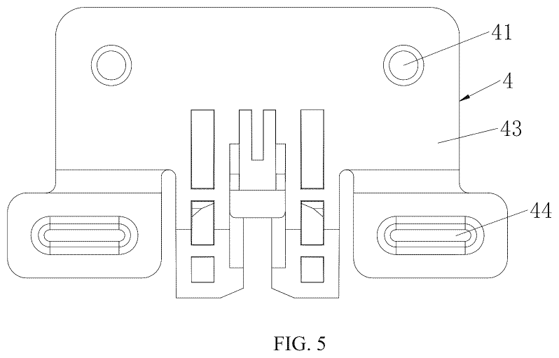

As shown in FIG. 4 and FIG. 5, in this embodiment, the pressing member 4 is provided with inserting columns 41, the movable cutter assembly 1 is provided with inserting holes 13, and the inserting columns 41 are inserted into the inserting holes 13, thereby ensuring accurate positioning of the movable cutter assembly 1 on the pressing member 4, facilitating quick mounting of the pressing member 4 on the movable cutter assembly 1, and facilitating keeping the stability of a cutter head of a shaver and the shaving accuracy. In addition, the pressing member 4 and the movable cutter assembly 1 are made of different materials, thereby reducing direct contact type structures between the same materials, reducing friction between the pressing member 4 and the movable cutter assembly 1, and improving the heat dissipation effect of the shaver.

As shown in FIG. 4 and FIG. 5, in this embodiment, limiting grooves 42 are formed in one side of the pressing member 4 away from the movable cutter assembly 1, a fixed end of the spring 5 is connected to the gasket 6, and pressure application ends of the spring 5 are disposed in the limiting grooves 42. The design of the limiting grooves 42 ensures that the spring 5 can be accurately positioned on the pressing member 4, thereby closely connecting the pressing member 4 to the movable cutter assembly 1, achieving synchronous movement of the pressing member 4 and the movable cutter assembly 1, and ensuring the harmony and consistency of the shaver in a working process.

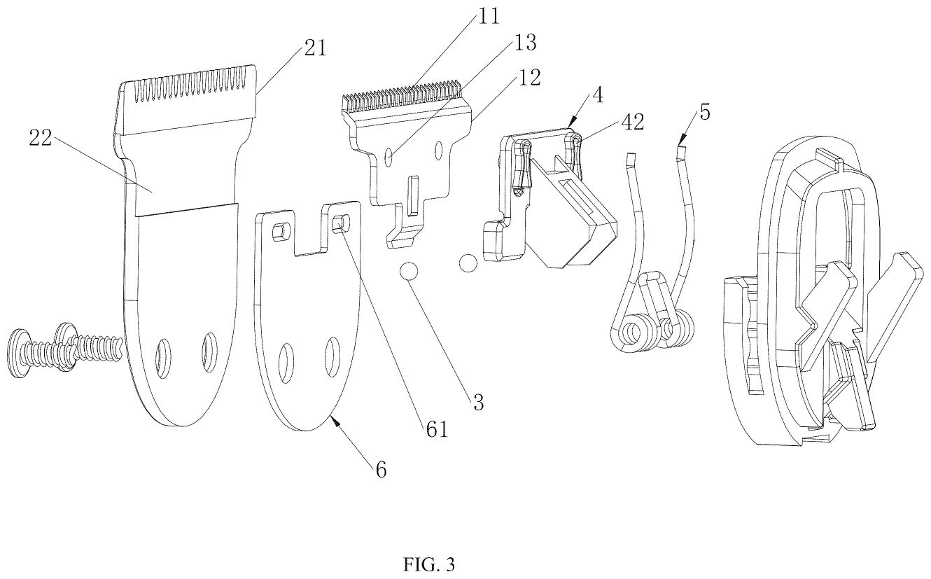

As shown in FIG. 2 to FIG. 5, in this embodiment, the pressing member 4 is provided with a first mounting position 43 and second mounting positions 44, at least part of the movable cutter assembly 1 is disposed at the first mounting position 43, and at least part of each of the rolling members 3 is disposed at the second mounting position 44; and by means of the pressing member 4, the length of the movable cutter assembly 1 can be reduced, the space utilization rate of the shaver can be increased, and the gasket 6 can be conveniently mounted inside the shaver. In addition, the gasket 6 is disposed on the side of the fixed cutter assembly 2 close to the movable cutter assembly 1, the gasket 6 is provided with limiting portions matched with the second mounting positions 44, at least part of each of the rolling members 3 is disposed in the limiting portion, that is, each of the rolling members 3 is disposed between the pressing member 4 and the gasket 6, and the direct sliding or rolling contact is achieved, so that the friction between the movable cutter assembly 1 and the fixed cutter assembly 2 can be reduced, thereby reducing the temperature of a cutter head, reducing the heat, then prolonging the service lives of the fixed cutter assembly 2 and the movable cutter assembly 1, and ensuring the long-term stability and reliability of the shaver. In addition, the movable cutter assembly is in horizontal and transverse sliding fit with the fixed cutter assembly to achieve parallel movement and cutting of a blade, and the blade can be closer to the skin to cut hair, thereby improving the cutting safety and comfort. Besides, the gasket 6 plays a role in limiting steel balls, and can also serve as a buffering layer between the fixed cutter assembly 2 and the movable cutter assembly 1 to further reduce friction and vibration.

As shown in FIG. 2 to FIG. 5, in this embodiment, the limiting portions on the gasket 6 are first sliding grooves 61, and the first sliding grooves 61 extend in a movement direction of the movable cutter assembly 1; and the first sliding grooves 61 provide accurate guidance for the rolling members 3 during working of the shaver, so that the rolling members 3 can move stably and linearly, and the movable cutter assembly 1 can be in horizontal and transverse sliding fit with the fixed cutter assembly 2 to shave the hair. Meanwhile, each of the second mounting positions 44 of the pressing member 4 includes an accommodating groove 441, and the accommodating groove 441 is matched with the first sliding groove 61, so that the rolling member 3 is limited between the two grooves, unnecessary movement or deviation of the rolling member 3 inside the shaver is avoided, it is ensured that the rolling member 3 cannot deviate from a predetermined rolling path, and the stability and consistency of the cutter head of the shaver are maintained. In addition, the rolling members 3 can be designed to be steel balls, and the steel balls have smoother surfaces, are high in hardness and are not prone to deformation, so that the service life can be ensured while the frictional resistance is reduced. Of course, during actual design, the structures of the rolling members 3 can be designed according to actual requirements.

As shown in FIG. 2 to FIG. 5, in this embodiment, each of the accommodating grooves 441 is recessed inwards to form a deformation groove 442, and the deformation groove 442 can be slightly deformed, so that the accommodating groove 441 can more closely wrap the rolling member 3, it is ensured that the rolling member 3 is maintained at the correct position during working of the shaver, the wear of the worn rolling member 3 in the shaving process can be compensated, the service life of the rolling member 3 can be prolonged, and the maintenance requirements of the shaver can be reduced. In addition, each of the deformation grooves 442 can avoid the top of the rolling member 3, thereby reducing the contact area of the rolling member 3 in the movement process inside the accommodating groove 441; and meanwhile, each of the deformation grooves 442 can store lubricating grease, thereby further reducing friction, and prolonging the service life of the rolling member 3.

As shown in FIG. 2, in this embodiment, an elastic deformation groove 431 is formed in the first mounting position 43 of the pressing member 4, and in an unassembled state of the pressing member 4, certain included angles are formed by the second mounting positions 44 of the pressing member 4 and the first mounting position 43. When the pressing member 4 is assembled, the pressing member 4 is pressed by the spring 5, so that the second mounting positions 44 and the first mounting position 43 are located on the same plane, that is, the elastic deformation groove 431 is deformed in the assembling process, and can be automatically adjusted according to the dimensional tolerance of each part.

As shown in FIG. 2, in this embodiment, at least part of the gasket 6 extends between the movable cutter assembly 1 and the fixed cutter assembly 2, which can reduce the direct friction between the movable cutter assembly 1 and the fixed cutter assembly 2 in the shaving process, and reduce noises and vibration; in addition, the gasket 6 can effectively dissipate the heat generated in the shaving process, thereby avoiding overheating of the movable cutter assembly 1 and the fixed cutter assembly 2, and prolonging the service lives of the movable cutter assembly 1 and the fixed cutter assembly 2. Of course, in other embodiments, it can also be designed such that the gasket 6 does not extend between the movable cutter assembly 1 and the fixed cutter assembly 2, and during actual design, the positional relationship among the gasket 6, the movable cutter assembly 1 and the fixed cutter assembly 2 can be designed according to actual requirements.

### Embodiment II

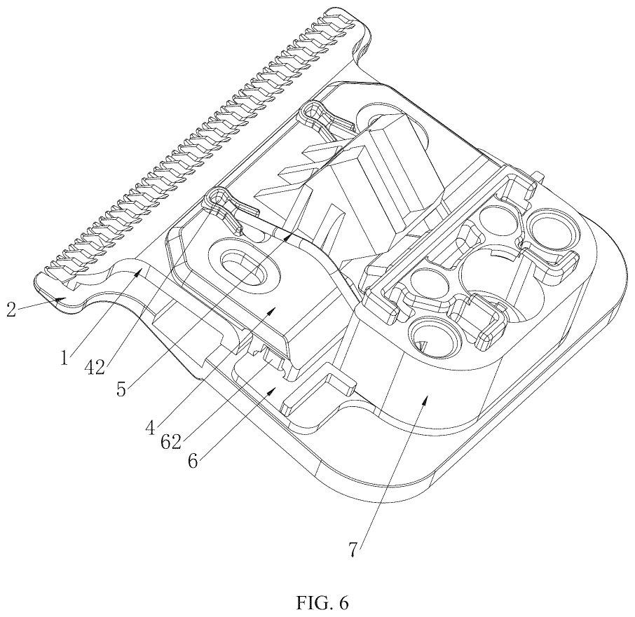

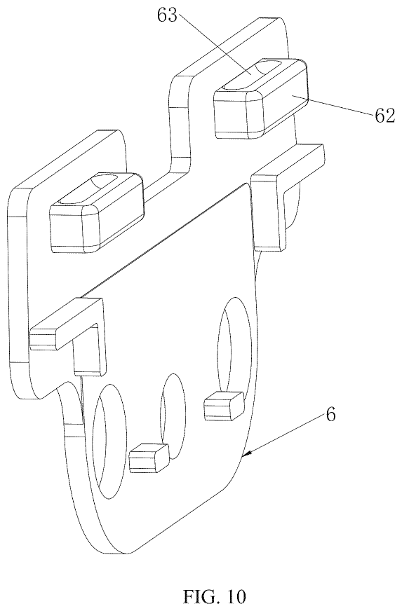

As shown in FIG. 6 to FIG. 10, different from Embodiment I, the gasket 6 in this embodiment is provided with bosses 62, second sliding grooves 63 serving as the limiting portions are formed on two sides of the bosses 62, and the second sliding grooves 63 extend in the movement direction of the movable cutter assembly 1, thereby ensuring that the rolling members 3 can roll stably along correct paths during working of the shaver.

As shown in FIG. 6 to FIG. 10, in this embodiment, each of the bosses 62 includes a first side surface and a second side surface, the first side surface and the second side surface extend in the movement direction of the movable cutter assembly 1, the first side surface and the second side surface are parallel to each other and are perpendicular to an upper surface of the gasket 6, and the two second sliding grooves 63 are respectively formed in the first side surface and the second side surface, that is, the boss 62 is in a cuboid shape, so that within the limited internal space of the shaver, the stability of one row of rolling members 3 can be extended into two rows, the rolling members 3 can be maintained to perform linear movement with the movable cutter assembly 1, and the stability and uniformity of the shaver during working are ensured. In addition, each of the second mounting positions 44 of the pressing member 4 includes an accommodating groove 441, and the accommodating groove 441 is matched with the second sliding groove 63, so that a plurality of rolling member 3 are limited between the two grooves, the rolling members 3 can roll along the second sliding groove 63, the friction between the pressing member 4 and the gasket 6 is reduced, the heat is reduced, and the service life of the shaver is prolonged.

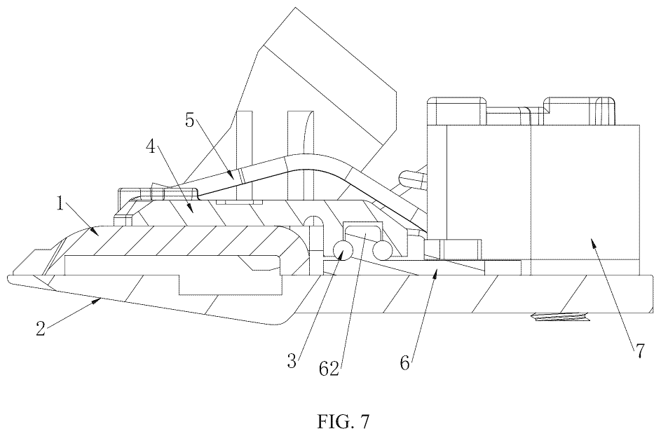

As shown in FIG. 7, in this embodiment, the pressing member 4 is connected to the gasket 6 by means of the bosses 62 and the rolling members 3, so that the contact area and pressure between the tail portion of the movable cutter assembly 1 and the tail portion of the fixed cutter assembly 2 can be reduced, thereby further reducing the friction between the two assemblies, and further reducing the temperature of the blade. In addition, in other embodiments, three or four rows of rolling members 3 can also be disposed on the gasket 6, thereby improving the stability of parallel movement of the movable cutter assembly 1 and the pressing member 4.

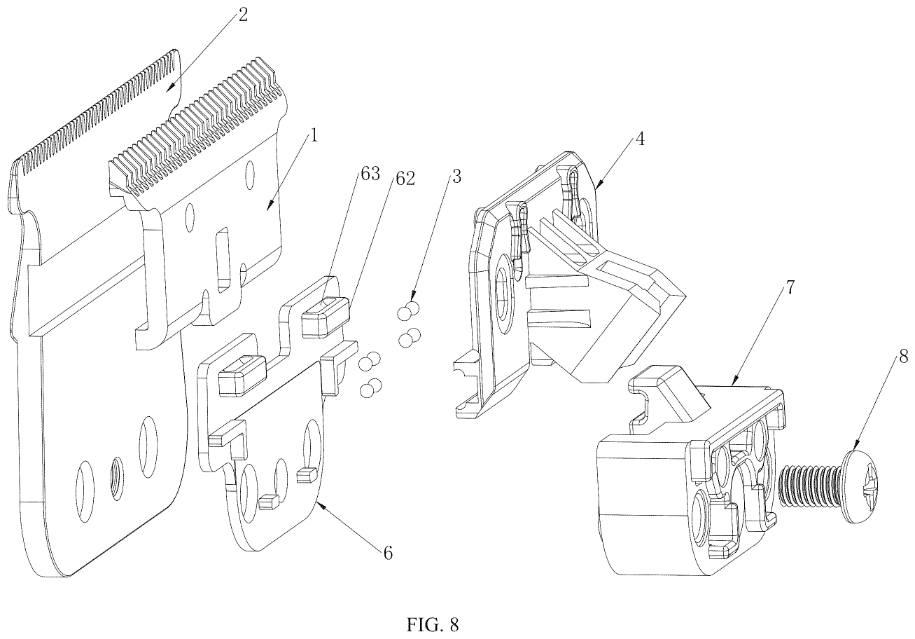

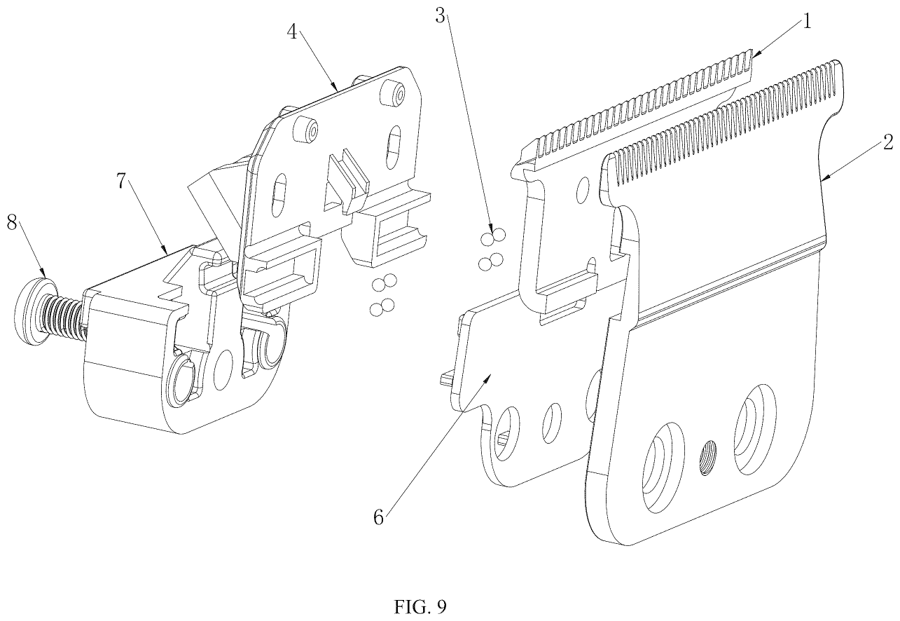

As shown in FIG. 8 to FIG. 9, in this embodiment, a fixing member 7 is disposed at the top of the gasket 6, the fixing member 7 is provided with a first connecting hole, the gasket 6 is provided with a second connecting hole, the fixed cutter assembly 2 is provided with a third connecting hole, and a connector 8 passes through the first connecting hole, the second connecting hole and the third connecting hole for matching, thereby connecting the gasket 6 to the movable cutter assembly 1. In addition, the connector 8 can be designed to be a screw. Of course, during actual design, the structure of the connector 8 can be designed according to actual requirements. Besides, in other embodiments, the fixing member 7 and the gasket 6 can also be designed to be integrally formed, thereby increasing the assembling speed.

### Embodiment III

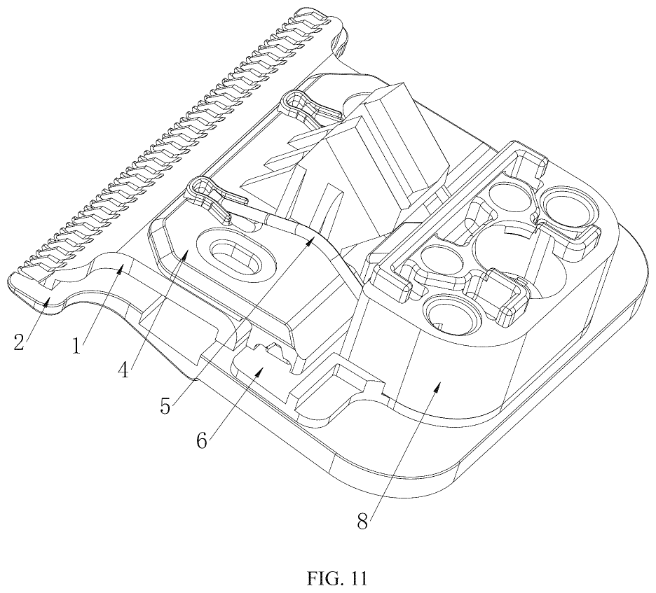

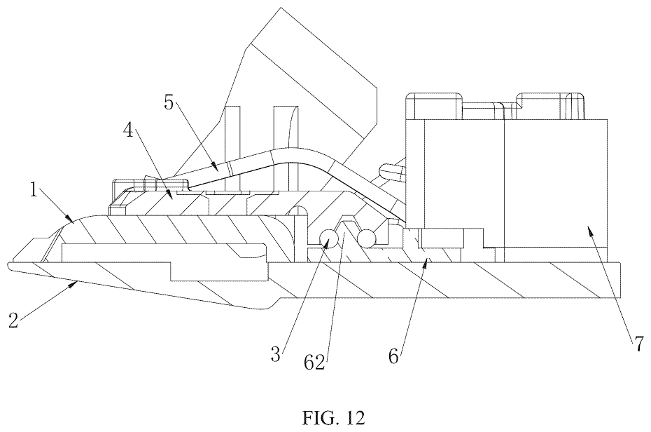

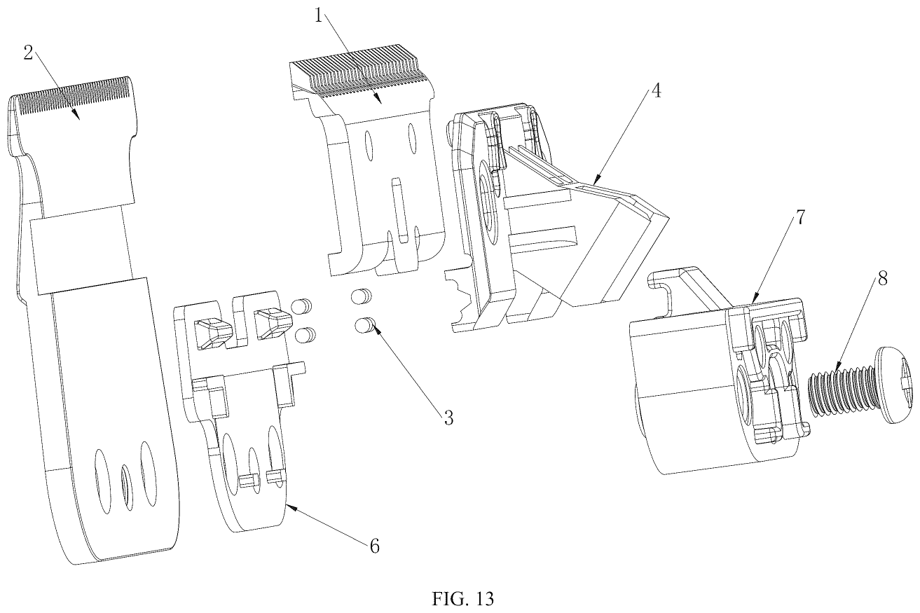

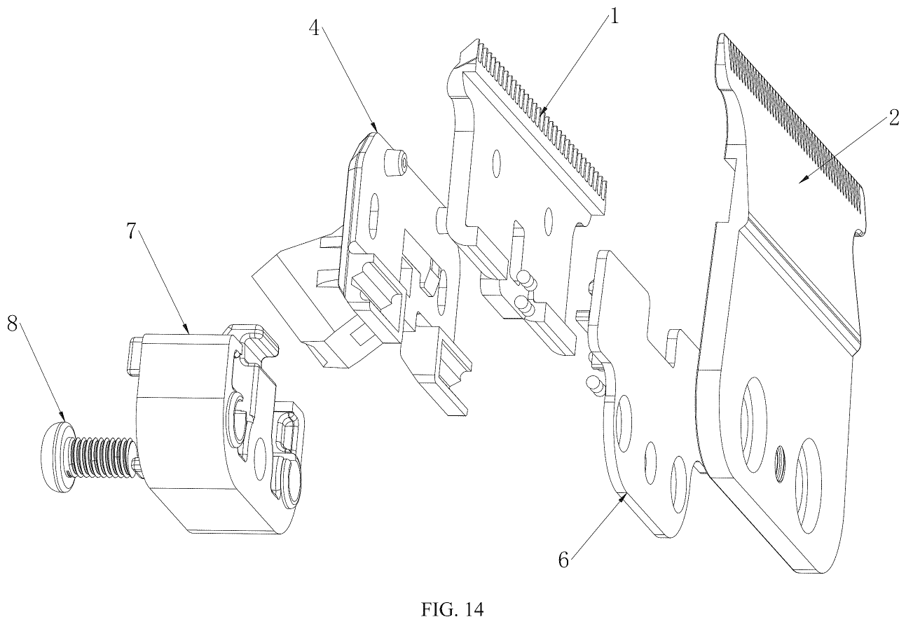

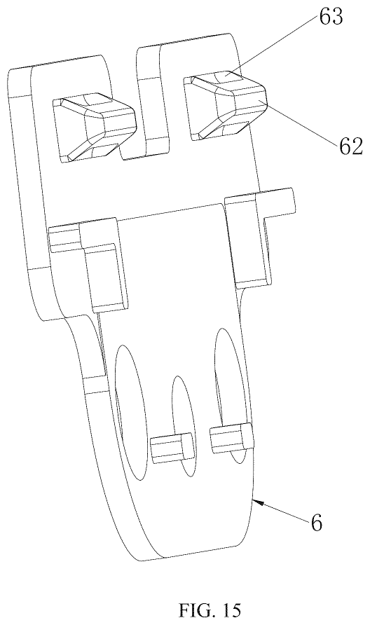

As shown in FIG. 11 to FIG. 15, different from Embodiment II, each of the bosses 62 in this embodiment includes a first side surface and a second side surface, the first side surface and the second side surface extend in the movement direction of the movable cutter assembly 1, and the first side surface and the second side surface are inclined inwards. In addition, each of the second mounting positions 44 of the pressing member 4 includes an accommodating groove 441, and the accommodating groove 441 is matched with the second sliding groove 63, so that a plurality of rolling member 3 are limited between the two grooves, the rolling members 3 can roll along the second sliding groove 63, the friction between the pressing member 4 and the gasket 6 is reduced, the heat is reduced, and the service life of the shaver is prolonged. It should be noted that the first side surface and the second side surface being inclined inwards means the first side surface and the second side surface being inclined towards each other, so that the boss 62 is in a quadrangular shape, and the use of the internal space of the shaver is optimized. Compared with Embodiment II, the bosses 62 in this embodiment can make the rolling members 3 be exposed out of the second sliding grooves 63 by more areas, so that the contact areas between the accommodating grooves 441 and the rolling members 3 can be larger, then the horizontal movement of the pressing member 4 and the movable cutter assembly 1 is more stable, and the shaving efficiency and quality of the shaver can be improved.

### Embodiment IV

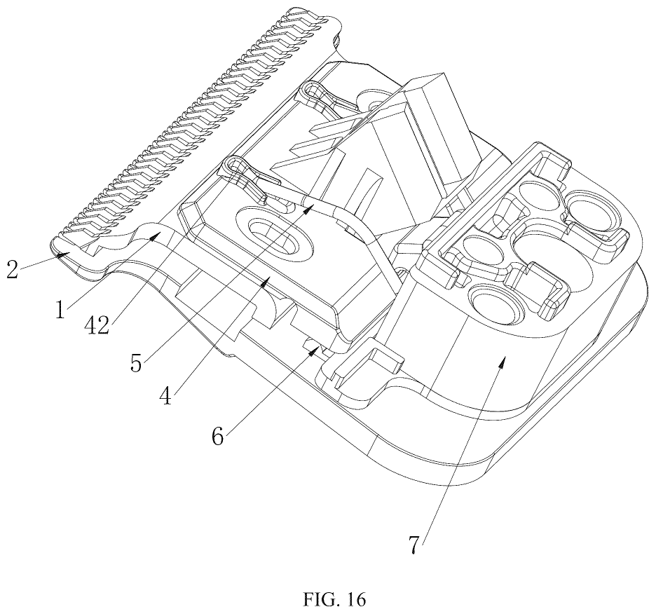

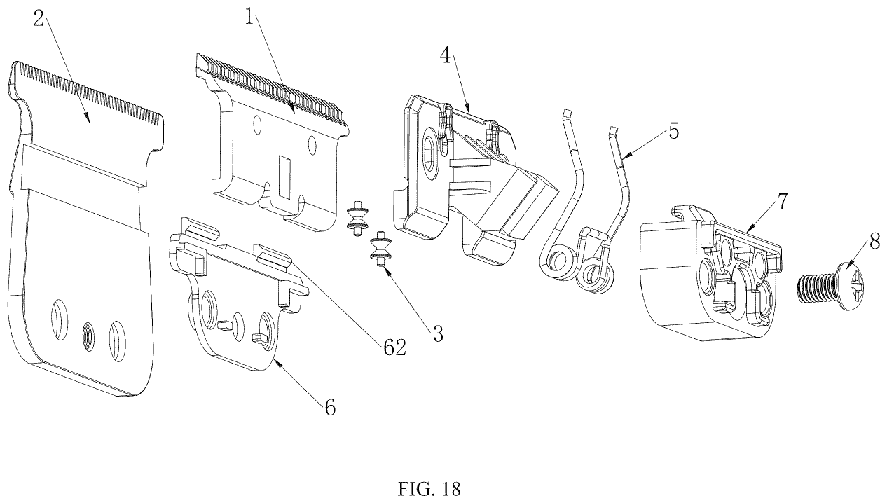

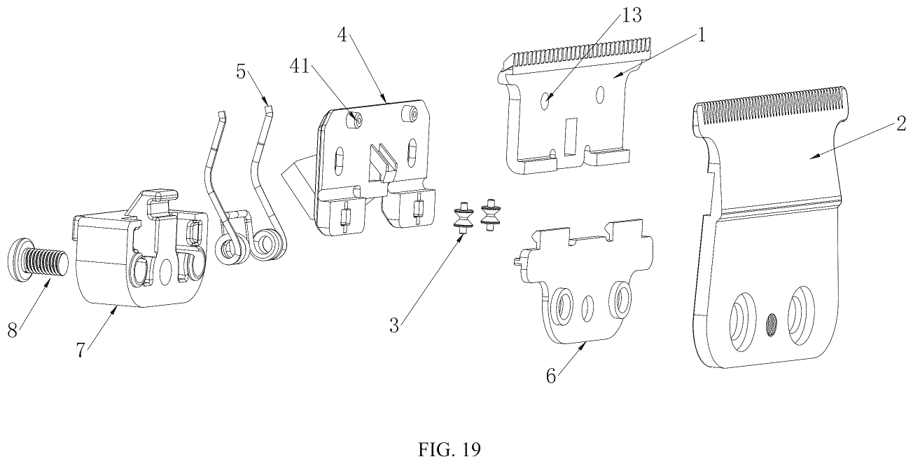

As shown in FIG. 16 to FIG. 21, different from Embodiment II and Embodiment III, each of the limiting portions in this embodiment is a boss 62, and the boss 62 extends in the movement direction of the movable cutter assembly 1; and each of the second mounting positions 44 of the pressing member 4 includes an accommodating groove 441, and the accommodating groove 441 is matched with the boss 62, so that the rolling member 3 is limited between the accommodating groove and the boss. In addition, the cross section of each boss 62 is in a triangular shape, which can enhance the strength and stability of the boss 62; an outer wall of each rolling member 3 is recessed inwards to form a groove 31 matched with the boss 62, so that at least part of the boss 62 is located inside the groove 31, and the rolling member 3 can roll along the boss 62, thereby reducing the friction between the pressing member 4 and the gasket 6, reducing the heat, and prolonging the service life of the shaver.

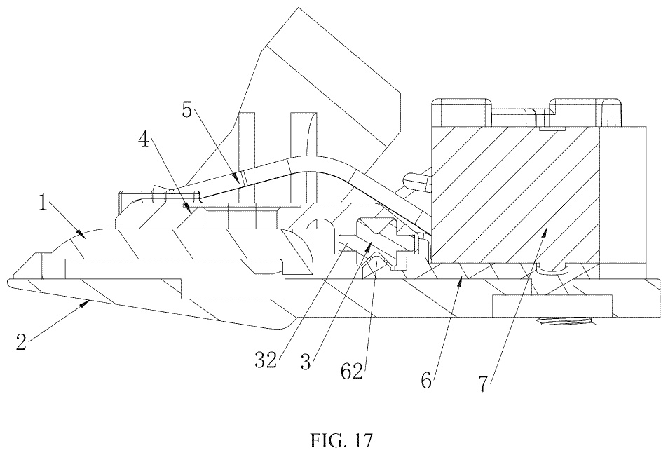

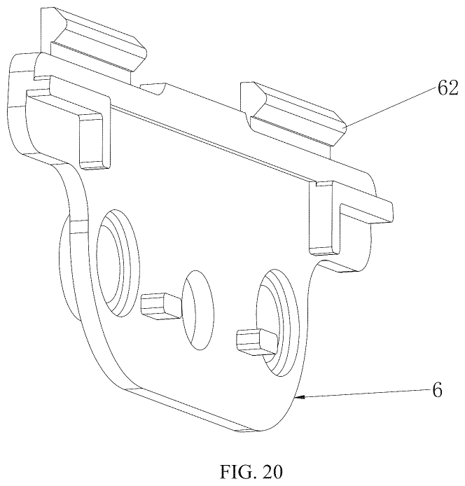

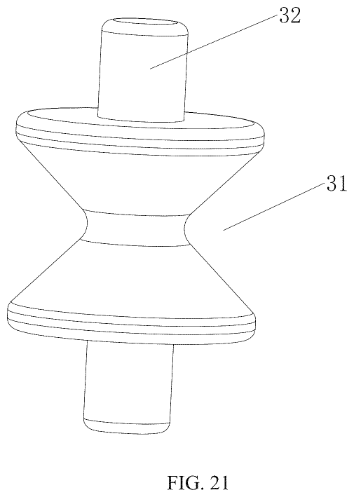

As shown in FIG. 17, FIG. 20 and FIG. 21, in this embodiment, rolling columns 32 are symmetrically provided at two ends of each rolling member 3, and the two rolling columns 32 are in contact with the inner wall of the accommodating groove 441 of the pressing member 4, so that the rolling member 3 can roll more smoothly and stably along the boss 62, thereby improving the assembling stability. In addition, the diameter of each rolling column 32 is less than that of the rolling member 3, so that the friction between the rolling member 3 and the pressing member 4 can be reduced. In addition, the rolling members 3 can be designed to be two. Of course, the number of the rolling members 3 can also be designed to be two or three, and during actual design, the number of the rolling members 3 can be designed according to actual requirements.

### Embodiment V

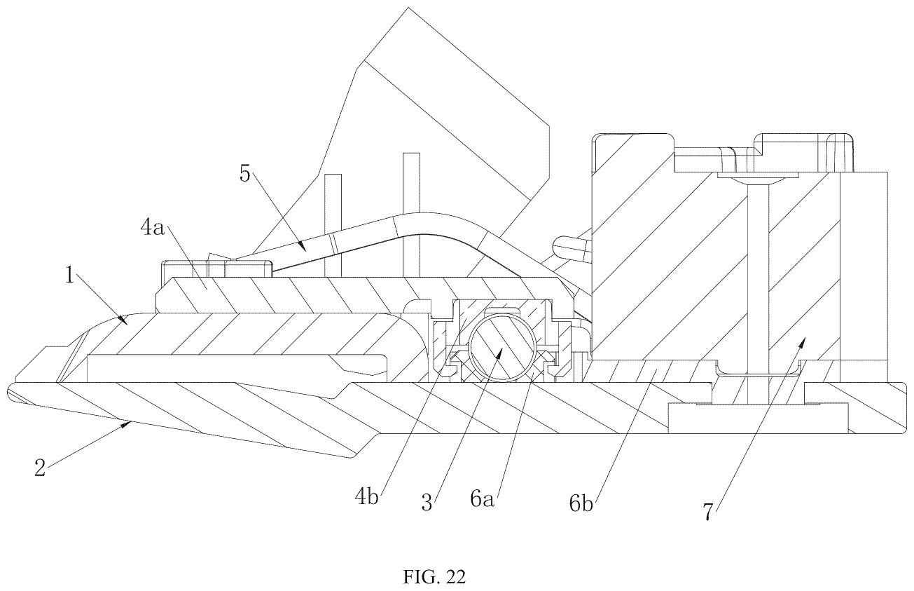

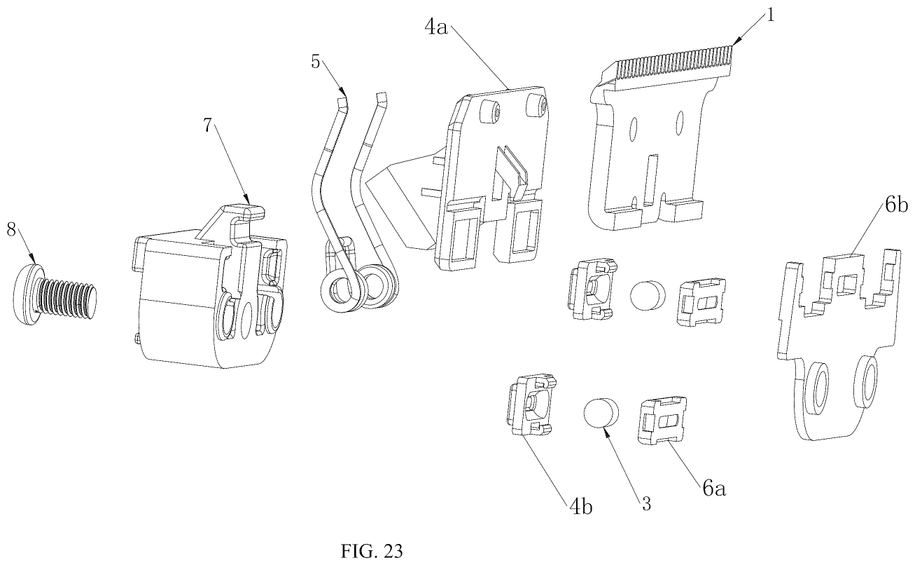

As shown in FIG. 22 to FIG. 23, different from Embodiment I, the pressing member 4 in this embodiment includes a first pressing member 4a and second pressing members 4b, the first mounting position 43 is provided on the first pressing member 4a, and the second mounting positions 44 are provided on the second pressing members 4b. In addition, the first pressing member 4a is provided with inserting blocks, the second pressing members 4b are provided with inserting grooves, and the inserting blocks are inserted into the inserting grooves, so that the first pressing member 4a can be detachably connected to the second pressing members 4b.

In this embodiment, the gasket 6 includes first gaskets 6a and a second gasket 6b, the second gasket 6b is provided with avoidance grooves, the avoidance grooves are internally provided with clamping protrusions, the first gaskets 6a are provided with clamping grooves, and the clamping protrusions are clamped and connected to the clamping grooves, so that the first gaskets 6a are detachably connected to the second gasket 6b. In addition, the limiting portions are disposed on the first gaskets 6a, the limiting portions are the first sliding grooves 61, and the first sliding grooves 61 extend in the movement direction of the movable cutter assembly 1, thereby providing accurate guidance for the rolling members 3 during working of the shaver.

In this embodiment, the rolling members 3 are disposed between the second pressing members 4b and the first gaskets 6a, the first pressing member 4a is detachably connected to the second pressing members 4b, and the first gaskets 6a are detachably connected to the second gasket 6b, so that the rolling members 3 are combined with the second pressing members 4b and the first gaskets 6a to form a detachable assembly, which can be mounted inside shavers of different models, the adaptability is improved, and the shaver is assembled more conveniently and quickly. In addition, the rolling members 3, the second pressing members 4b and the first gaskets 6a are relatively small, so that the sizes can be controlled better, and machining is more convenient. Besides, the detachable assemblies formed by combining the rolling members 3 with the second pressing members 4b and the first gaskets 6a can be designed to be two, and the two detachable assemblies are symmetrically disposed on two sides of the second gasket 6b, so that the shaver is assembled more stably.

In this embodiment, the first gaskets 6a are provided with guide portions, the second pressing members 4b are provided with sliding portions, the guide portions extend in the movement direction of the movable cutter assembly 1, and the sliding portions are clamped into the bottoms of the guide portions, so that the sliding portions can move along the guide portions, and the horizontal and transverse sliding of the movable cutter assembly 1 relative to the fixed cutter assembly 2 can be achieved to cut the hair.

In this embodiment, a fixing member 7 is disposed at the top of the second gasket 6b, the fixing member 7 is provided with a first connecting hole, the second gasket 6b is provided with a second connecting hole, the fixed cutter assembly 2 is provided with a third connecting hole, and a connector 8 passes through the first connecting hole, the second connecting hole and the third connecting hole for matching, thereby connecting the second gasket 6b to the movable cutter assembly 1. In addition, the connector 8 can be designed to be a screw. Of course, during actual design, the structure of the connector 8 can be designed according to actual requirements. Besides, in other embodiments, the fixing member 7 and the second gasket 6b can also be designed to be integrally formed, thereby increasing the assembling speed.

The present invention patent is described demonstratively above in conjunction with drawings, it is obvious that the realization of the present invention patent is not limited by the above-mentioned manner, and any improvement made by means of the method concept and the technical solution of the present invention patent, or the direct application of the concept and the technical solution of the present invention patent to other situations without involving any improvement should fall within the scope of protection of the present invention.

What is claimed is:

1. A cutter head structure capable of achieving parallel movement, comprising a movable cutter assembly, a fixed cutter assembly, and rolling members, wherein the movable cutter assembly is in horizontal and transverse sliding fit with the fixed cutter assembly; and the cutter head structure further comprises:
a pressing member, wherein the pressing member is provided with a first mounting position and second mounting positions, at least part of the movable cutter assembly is disposed at the first mounting position, and at least part of each of the rolling members is disposed at the second mounting position; and
a gasket, wherein the gasket is disposed on one side of the fixed cutter assembly close to the movable cutter assembly, the gasket is provided with limiting portions matched with the second mounting positions, and at least part of each of the rolling members is disposed in the limiting portion.

2. The cutter head structure capable of achieving parallel movement according to claim 1, wherein the fixed cutter assembly comprises a fixed cutter head portion, the movable cutter assembly comprises a movable cutter head portion, the fixed cutter head portion is in contact with the movable cutter head portion, the fixed cutter head portion is bent towards one side close to the pressing member to form a fixed cutter tail portion, and the movable cutter head portion is bent towards one side away from the pressing member to form a movable cutter tail portion, so that a gap is formed between the fixed cutter tail portion and the movable cutter tail portion.

3. The cutter head structure capable of achieving parallel movement according to claim 1, wherein each of the limiting portions is a sliding groove, and the sliding groove extends in a movement direction of the movable cutter assembly; and each of the second mounting positions comprises an accommodating groove, and the accommodating groove is matched with the sliding groove, so that the rolling member is limited between the accommodating groove and the sliding groove.

4. The cutter head structure capable of achieving parallel movement according to claim 3, wherein each of the accommodating grooves is recessed inwards to form a deformation groove which facilitates the accommodating groove wrapping the rolling member.

5. The cutter head structure capable of achieving parallel movement according to claim 1, wherein the gasket is provided with bosses, sliding grooves serving as the limiting portions are provided on two sides of the bosses, and the sliding grooves extend in a movement direction of the movable cutter assembly.

6. The cutter head structure capable of achieving parallel movement according to claim 5, wherein each of the bosses comprises a first side surface and a second side surface, the first side surface and the second side surface extend in the movement direction of the movable cutter assembly, and the first side surface and the second side surface are parallel to each other and are perpendicular to an upper surface of the gasket; and
each of the second mounting positions comprises an accommodating groove, and the accommodating groove is matched with the sliding groove, so that the plurality of rolling members are limited between the accommodating groove and the sliding groove.

7. The cutter head structure capable of achieving parallel movement according to claim 5, wherein each of the bosses comprises a first side surface and a second side surface, the first side surface and the second side surface extend in the movement direction of the movable cutter assembly, and the first side surface and the second side surface are inclined inwards; and
each of the second mounting positions comprises an accommodating groove, and the accommodating groove is matched with the sliding groove, so that the plurality of rolling members are limited between the accommodating groove and the sliding groove.

8. The cutter head structure capable of achieving parallel movement according to claim 1, wherein each of the limiting portions is a boss, and the boss extends in a movement direction of the movable cutter assembly; and each of the second mounting positions comprises an accommodating groove, and the accommodating groove is matched with the boss, so that the rolling member is limited between the accommodating groove and the boss.

9. The cutter head structure capable of achieving parallel movement according to claim 1, wherein the pressing member is provided with inserting columns, the movable cutter assembly is provided with inserting holes, and the inserting columns are inserted into the inserting holes.

10. The cutter head structure capable of achieving parallel movement according to claim 1, further comprising a spring, wherein limiting grooves are formed in one side of the pressing member away from the movable cutter assembly, a fixed end of the spring is connected to the gasket, and pressure application ends of the spring are disposed in the limiting grooves.
